(19) United States
(12) Patent Application Publication
(10) Pub. No.: US 2016/0138871 A1
(43) Pub. Date: May 19, 2016

(54) DUPLEX HEAT EXCHANGER

(71) Applicant: SANDEN HOLDINGS CORPORATION, Isesaki-shi, Gunma (JP)

(72) Inventor: Yuuichi MATSUMOTO, Isesaki-shi, Gunma (JP)

(21) Appl. No.: 14/893,629

(22) PCT Filed: May 22, 2014
(86) PCT No.: PCT/JP2014/063604

§ 371 Date: Nov. 24, 2015

(30) Foreign Application Priority Data
May 24, 2013 (JP) 2013-110204

(51) Int. Cl. F28D 1/053; B60H 1/00; F28F 9/26

(52) U.S. Cl. CPC F28D 1/05341; F28F 9/26; B60H 1/00328

(57) ABSTRACT

A connection structure for front and rear header tanks 102 and 202 in a duplex heat exchanger is provided. A connecting member 300 includes two identically shaped long and narrow plate members 301 and 302, a plurality of communication holes 301a and 302a having boss portions 301b and 302b protruding cylindrically by burring from one surface of each of the plate members 301 and 302, is formed to be arranged on the plate members, and the plate members 301 and 302 are joined to each other back to back. The connecting member 300 is disposed between two header tanks 102 and 202 which communicate with each other, and the boss portions 301b and 302b are inserted into holes 102c and 202c formed on the header tanks 102 and 202, so that the connecting member 300 is joined to the header tanks 102 and 202.

### TECHNICAL FIELD

The present invention relates to a duplex heat exchanger in which a plurality of heat exchange units is disposed so as to be arranged in an air flow direction, and in particular, relates to a connection structure between heat exchange units.

### BACKGROUND ART

As described in Patent Document 1, in a duplex heat exchanger, a plurality of heat exchange units is disposed so as to be arranged in an air flow direction, each heat exchange unit is configured to include a pair of cylindrical header tanks disposed in parallel with each other and a plurality of tubes communicating with the pair of header tanks in parallel, and heat exchange is performed between a refrigerant flowing through the tubes and air flowing through a gap between the tubes.

Here, in a four-pass counter-flow method, after a refrigerant meanderingly flows to a heat exchange unit on a rear side (a downstream side) in the air flow direction with two passes (first pass and second pass), the refrigerant meanderingly flows to a heat exchange unit on a front side (an upstream side) with two passes (third pass and fourth pass).

In this case, a connection between the second pass of the rear side heat exchange unit and the third pass of the front side heat exchange unit is achieved by a configuration in which header tanks disposed on one side communicate with each other via a connecting member.

In Patent Document 1, as the connecting member (joint member), a connecting member is used in which a pipe member is inserted into a communication hole formed of an aluminum extruded member and both end portions of the pipe member protrude outward.

### REFERENCE DOCUMENT LIST

### Patent Document

Patent Document 1: Japanese Patent Application Laid-open Publication No. H11-142087

### SUMMARY OF THE INVENTION

### Problems to be Solved by the Invention

However, in a technique described in Patent Document 1, assuming that two header tanks communicate with each other at one location, the connecting member is used in which the pipe member is inserted into the communication hole formed of an aluminum extruded member and both end portions of the pipe member protrude outward.

Accordingly, when the number of the communication locations increases in order to decrease flow resistance, the pipe member is required as the number of the communication locations increases, the number of parts increases, and the number of assembly steps increases.

In particular, in a case in which the heat exchanger is configured to be disposed in an air blowing path in a heat pump type air conditioner for a vehicle, during heating operation, the heat exchanger is used as a condenser which heats air by condensing a refrigerant from a compressor, and during cooling operation, the heat exchanger is configured to interrupt blown air to pass the refrigerant from the compressor in a gas state to thereby supply the refrigerant to an exterior condenser, it is necessary to decrease the flow resistance of the heat exchanger. In this case, it is an important problem to be solved to decrease the flow resistance by increasing communication locations between header tanks, and it is very important to solve the problem without increasing the number of parts or assembly steps.

In view of the aforementioned problems, an object of the present invention is to provide a connection structure between heat exchange units, which is able to decrease flow resistance without increasing the number of parts or assembly steps.

### Means for Solving the Problems

According to an aspect of the present invention, a duplex heat exchanger includes at least two heat exchange units which include: a pair of cylindrical header tanks disposed in parallel with each other; and a plurality of tubes which communicates in parallel with the pair of header tanks, and which perform heat exchange between a refrigerant flowing through the tubes and air flowing through gaps between the tubes, in which the heat exchange units are disposed to be arranged in upstream and downstream sides in an air flow direction, and the header tanks are positioned on one side communicate with each other via a connecting member.

Here, the connecting member includes two identically shaped long and narrow plate members, a plurality of communication holes having boss portions protruding cylindrically by burring from one surface of each of the plate members, is formed to be arranged on the plate members, and the plate members are joined to each other back to back. Furthermore, the connecting member is disposed between two header tanks which communicate with each other, and the boss portions are inserted into holes formed on the header tanks, so that the connecting member is joined to the header tanks.

### Effects of the Invention

According to the present invention, the connecting member may be configured of two identically shaped plate members formed by simple processing, and communication may be achieved by the plurality of communication holes. Accordingly, it is possible to obtain effects of decreasing flow resistance without increasing the number of parts or assembly steps.

### BRIEF DESCRIPTION OF THE DRAWINGS

FIG. 1 is a schematic view illustrating a refrigerant circuit of an air conditioner for a vehicle of an embodiment of the present invention during heating operation.

FIG. 2 is a schematic view illustrating the refrigerant circuit of the air conditioner for the vehicle during cooling operation.

FIG. 3 is a schematic perspective view illustrating a duplex heat exchanger of an embodiment of the present invention.

FIG. 4 is a front view of the duplex heat exchanger.

FIG. 5 is a side view of the duplex heat exchanger (which is viewed from A-A of FIG. 4).

FIG. 6 is a sectional view taken along B-B of FIG. 4.

FIG. 7 is a plan view of the duplex heat exchanger (which is viewed from C-C of FIG. 4).

FIG. 8 is a sectional view taken along D-D of FIG. 4.

FIG. 9 is a sectional view taken along E-E of FIG. 4.

FIG. 10 is a schematic perspective view illustrating a pass configuration of the duplex heat exchanger.

FIG. 11 is a perspective view of a connecting member.

FIG. 12 is an assembly process view of a connecting portion including the connecting member when viewed from a cross section.

FIG. 13 is an assembly process view of the connecting portion including the connecting member when viewed from a vertical section.

### MODE FOR CARRYING OUT THE INVENTION

Hereinafter, an embodiment of the present invention will be described in detail.

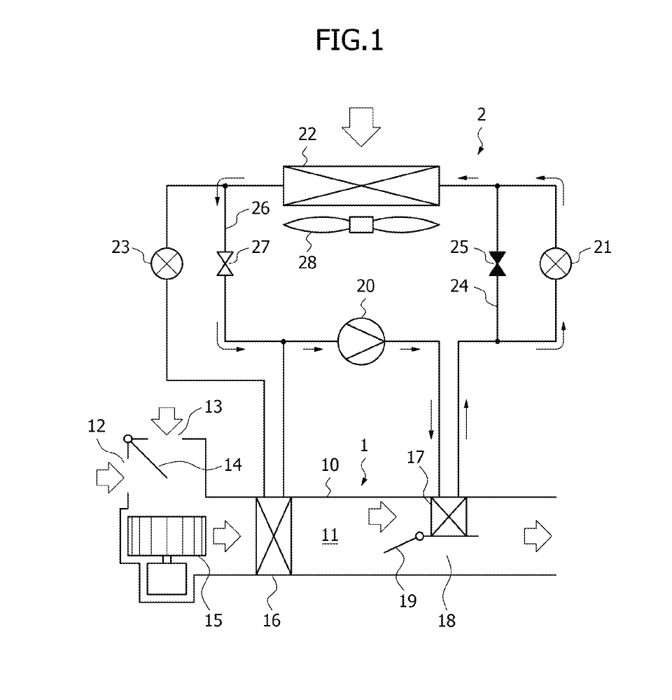

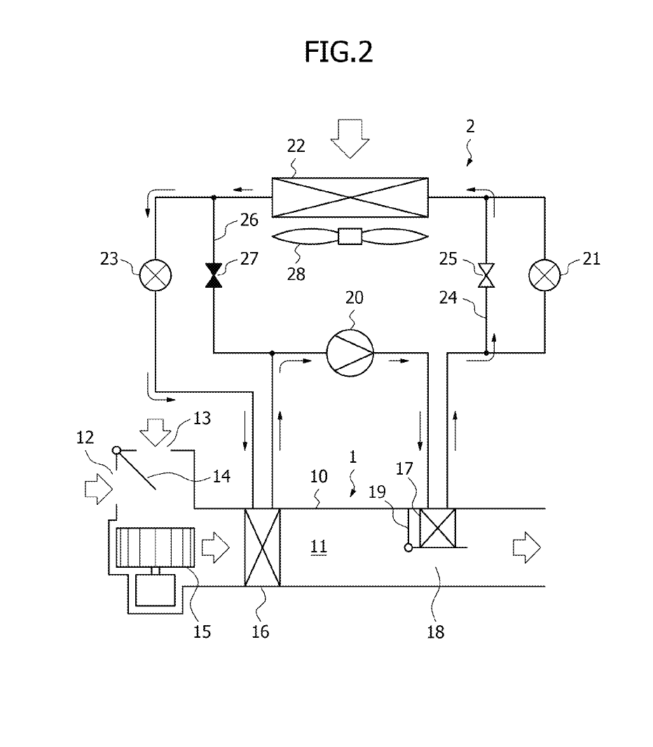

FIGS. 1 and 2 are schematic views illustrating a refrigerant circuit of an air conditioner for a vehicle of an embodiment of the present invention, and a duplex heat exchanger according to the present invention is provided as a second vehicle interior heat exchanger 17. FIG. 1 illustrates the refrigerant circuit during heating operation, and FIG. 2 illustrates the refrigerant circuit during cooling operation.

The air conditioner for the vehicle is configured to include: a Heating Ventilation and Air Conditioning (HVAC) unit 1 which is disposed in the interior of a vehicle (including a vehicle driven by an engine, an electric vehicle, and a hybrid vehicle), draws air inside the interior of a vehicle (inside air) or air outside a vehicle (outside air), adjusts the temperature of the air, and blows the air into the interior of a vehicle; and a heat pump circuit 2 which is disposed outside of the interior of a vehicle and performs heat exchange with the HVAC unit 1 using a chlorofluorocarbon-based refrigerant.

The HVAC unit 1 includes an air blowing path 11 which is formed by a housing 10, an inside air intake port 12 and an outside air intake port 13 which are formed as inlets of the air blowing path 11, an inside and outside air changeover damper 14 which selectively switches the intake ports 12 and 13, a blower 15 which draws air (inside air or outside air) from the intake ports 12 or 13 to send the air to the air blowing path 11, a first vehicle interior heat exchanger 16 for cooling which is provided on an approximately upstream side of the air blowing path 11, a second vehicle interior heat exchanger 17 for heating which is provided on an approximately downstream side of the air blowing path 11, a bypass path 18 which bypasses the second vehicle interior heat exchanger 17, and an air mix damper 19.

The air mix damper 19 controls a flow of air toward the second vehicle interior heat exchanger 17 and the bypass path 18, and has a function which interrupts a flow of air toward the second vehicle interior heat exchanger 17 during cooling operation, as illustrated in FIG. 2.

Although an outlet side of the air blowing path 11 is not illustrated, a defrost blowing outlet, a face blowing outlet, and a foot blowing outlet are provided on the outlet side in order to blow temperature-controlled air in an appropriate direction, and the outlets are opened and closed by each damper.

The heat pump circuit 2 circulates a chlorofluorocarbon-based refrigerant, and includes the first vehicle interior heat exchanger 16 and the second vehicle interior heat exchanger 17.

The heat pump circuit 2 includes the first vehicle interior heat exchanger 16, a compressor 20 to which an outlet side pipe of the first vehicle interior heat exchanger 16 is connected, the second vehicle interior heat exchanger 17 to which an outlet side pipe of the compressor 20 is connected, decompression unit 21 such as an expansion valve to which an outlet side pipe of the second vehicle interior heat exchanger 17 is connected, and an vehicle exterior heat exchanger 22 to which an outlet side pipe of the decompression unit 21 is connected, and decompression unit 23 such as an expansion valve to which an outlet side pipe of the vehicle exterior heat exchanger 22 is connected, and an outlet side pipe of the decompression unit 23 is connected to the first vehicle interior heat exchanger 16.

The vehicle exterior heat exchanger 22 is disposed outside the interior of a vehicle, and specifically, is disposed on a front surface of a vehicle, and receives air blown by the fan 28 or wind generated when a vehicle travels, to perform heat exchange with outside air.

A bypass pipe 24 which bypasses the decompression unit 21 is provided. Here, according to a control of an on-off valve 25 provided in the bypass pipe 24 or the like, a refrigerant flows to the bypass pipe 24 during cooling operation, and the refrigerant flows to the decompression unit 21 during heating operation.

Furthermore, a bypass pipe 26 which bypasses the decompression unit 23 and the first vehicle interior heat exchanger 16 is provided in the decompression unit 23 and the first vehicle interior heat exchanger 16. Here, according to control of an on-off valve 27 provided in the bypass pipe 26 or the like, the refrigerant flows to the decompression unit 23 and the first vehicle interior heat exchanger 16 during cooling operation, and the refrigerant flows to the bypass pipe 26 during heating operation.

Moreover, in order to control the flows, in addition to the on-off valves 25 and 27, a one-way valve or the like is appropriately provided. However, this is omitted here.

Next, each operation of the air conditioner for a vehicle will be described in a case in which heating operation is performed and cooling operation is performed.

During heating operation, as illustrated in FIG. 1, the on-off valve 25 of the bypass pipe 24 is closed, the on-off valve 27 of the bypass pipe 26 is opened, and a refrigerant circulates as illustrated by arrows of FIG. 1.

Since the first vehicle interior heat exchanger 16 is bypassed, the refrigerant does not flow to the first vehicle interior heat exchanger 16 in the HVAC unit 1. Accordingly, heat exchange between air and the refrigerant in the first vehicle interior heat exchanger 16 is not performed by only the air passing through the first vehicle interior heat exchanger 16. The air mix damper 19 opens the second vehicle interior heat exchanger 17. Accordingly, air flows into the second vehicle interior heat exchanger 17, and heat exchange between the air and the refrigerant in the second vehicle interior heat exchanger 17 is performed.

In the heat pump circuit 2, first, high-temperature and high-pressure gas refrigerant compressed by the compressor 20 flows into the second vehicle interior heat exchanger 17 which functions as a condenser during heating operation, to be cooled by heat exchange which is performed with air, to be thereby condensed and liquefied. In this case, the air is heated by the second vehicle interior heat exchanger 17, to be blown from the blow outlet disposed on the downstream side of the air blowing path 11, to be supplied for heating the interior of a vehicle.

After the refrigerant condensed by the second vehicle interior heat exchanger 17 is adiabatically expanded and decompressed by the decompression unit 21 such as an expansion valve, the refrigerant becomes a gas-liquid two-phase refrigerant and flows into the vehicle exterior heat exchanger 22 which functions as an evaporator during heating operation. In the vehicle exterior heat exchanger 22, after the gas-liquid two-phase refrigerant absorbs heat from outside air by air blown by the fan 28 or wind generated when a vehicle travels and is evaporated and gasified, the refrigerant is drawn into the compressor 20 through the bypass pipe 26 to be compressed again.

During cooling operation, as illustrated in FIG. 2, the on-off valve 25 of the bypass pipe 24 is opened, the on-off valve 27 of the bypass pipe 26 is closed, and a refrigerant circulates as illustrated by arrows of FIG. 2.

In the HVAC unit 1, since the refrigerant flows to the first vehicle interior heat exchanger 16, heat exchange is performed between air and the refrigerant in the first vehicle interior heat exchanger 16. An air mix damper 19 closes the second vehicle interior heat exchanger 17. Accordingly, air does not flow into the second vehicle interior heat exchanger 17, and heat exchange between the air and the refrigerant in the second vehicle interior heat exchanger 17 is not performed.

In the heat pump circuit 2, first, high-temperature and high-pressure gas refrigerant compressed by the compressor 20 flows into the second vehicle interior heat exchanger 17. However, since the air mix damper 19 is closed, heat exchange between the refrigerant and air is not performed, and the refrigerant passes the second vehicle interior heat exchanger 17 without performing any operation. Accordingly, the high-temperature and high-pressure gas refrigerant compressed by the compressor 20 passes through the bypass pipe 24 as it is, and flows into the vehicle exterior heat exchanger 22 which functions as a condenser during cooling operation. Therefore, the high-temperature and high-pressure gas refrigerant dissipates heat to outside air in the vehicle exterior heat exchanger 22, to be condensed and liquefied.

After the refrigerant condensed by the vehicle exterior heat exchanger 22 is adiabatically expanded and decompressed by the decompression unit 23 such as an expansion valve, the refrigerant becomes a gas-liquid two-phase refrigerant and flows into the first vehicle interior heat exchanger 16 which functions as an evaporator during cooling operation. The refrigerant which has flowed into the first vehicle interior heat exchanger 16 is heated by heat exchange between the refrigerant and air fed from each intake port to the air blowing path 11, to be evaporated and gasified. In this case, the air cooled by the first vehicle interior heat exchanger 16 is blown from the blow outlet disposed on the downstream side of the air blowing path 11, to be supplied for cooling the interior of a vehicle.

The refrigerant passing through the first vehicle interior heat exchanger 16 is drawn to the compressor 20 to be compressed again.

Accordingly, in the air conditioner of the vehicle, the second vehicle interior heat exchanger 17 is disposed in the air blowing path 11 of the HVAC unit 1 and is used as a condenser which heats air by condensing the refrigerant from the compressor 20 during the heating operation. During the cooling operation, the second vehicle interior heat exchanger 17 is configured to interrupt the blown air by the air mix damper 19, to pass the refrigerant from the compressor 20 in a gas state, to thereby supply the refrigerant to the exterior condenser (vehicle exterior heat exchanger 22). Comparing a case in which the refrigerant bypasses the second vehicle interior heat exchanger 17 during cooling operation, it is possible to omit piping and valves for performing the bypass to thereby achieve a reduction in costs.

Next, a specific configuration of the duplex heat exchanger configuring the second vehicle interior heat exchanger 17 in the air conditioner for the vehicle will be described.

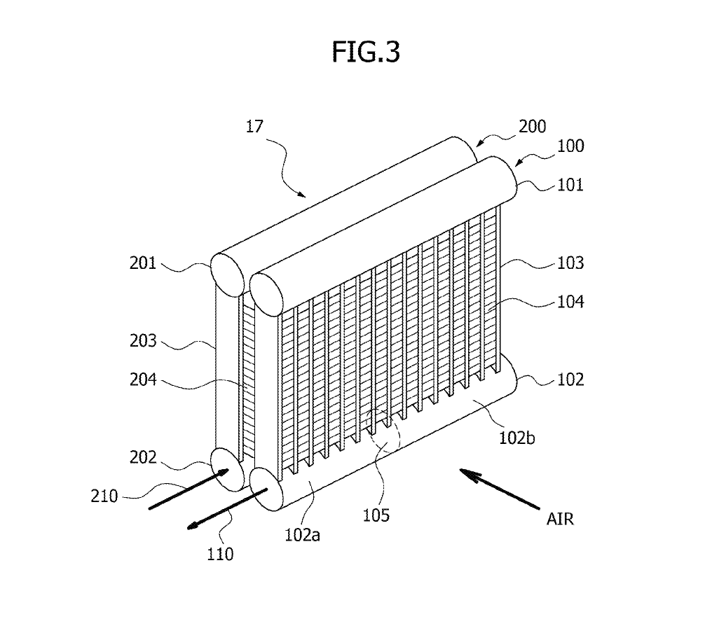

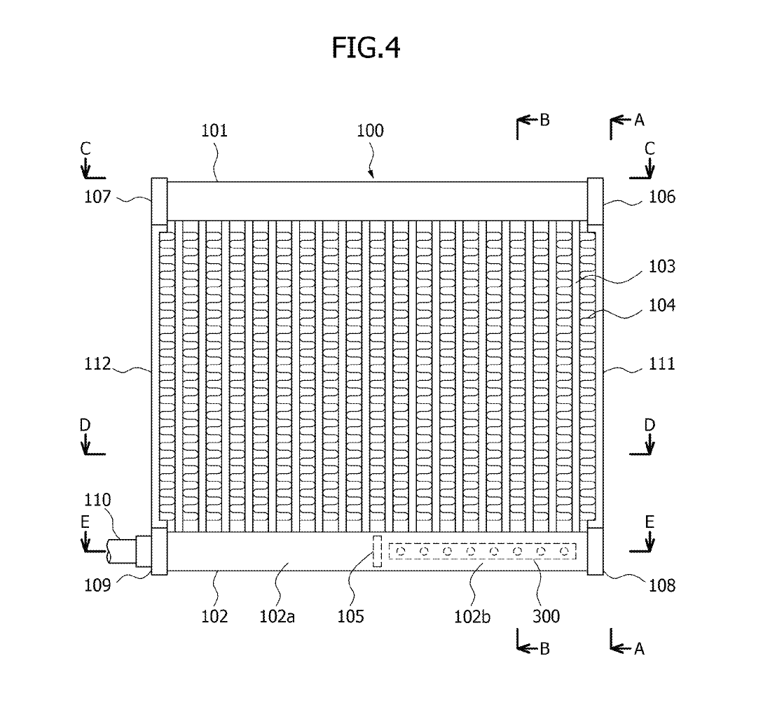

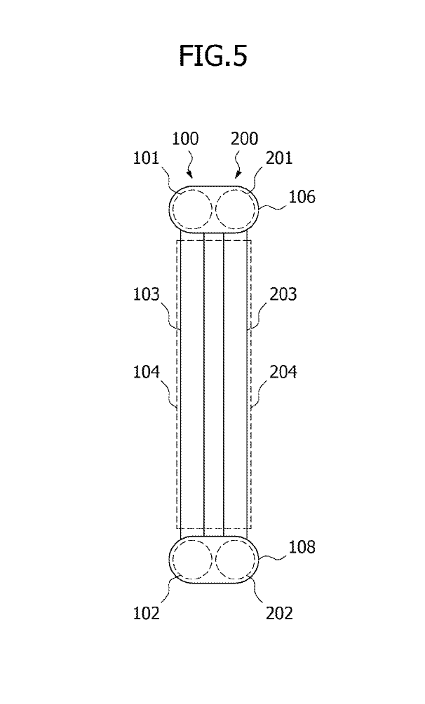

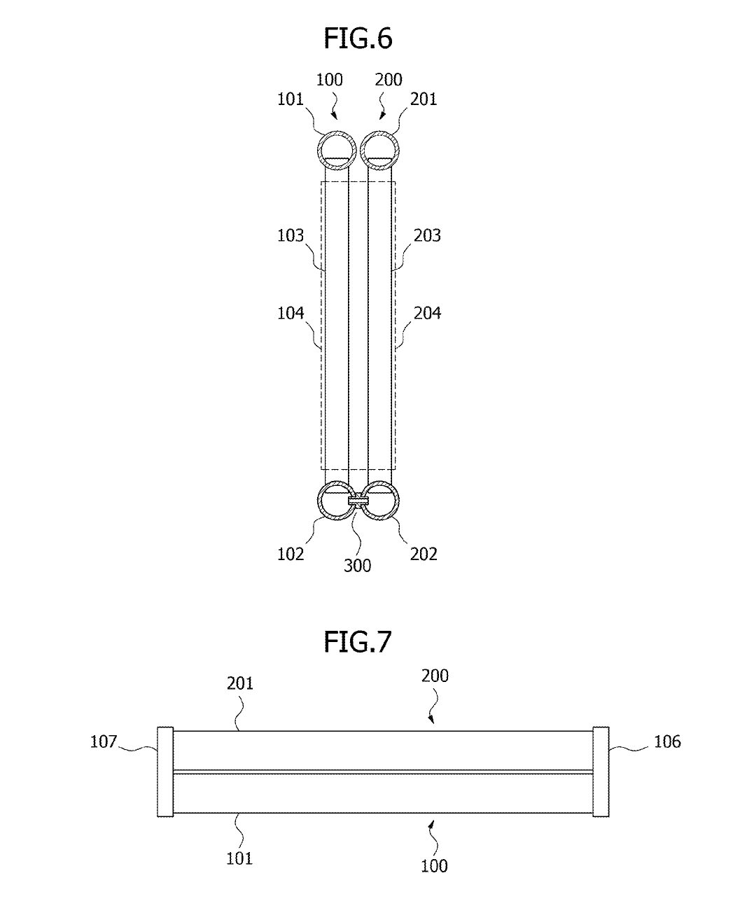

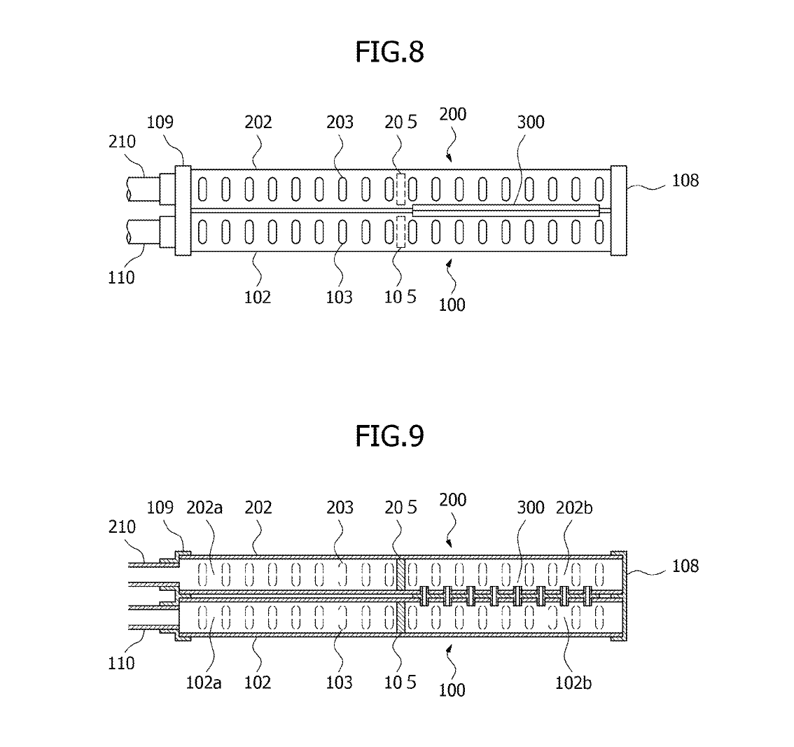

FIG. 3 is a schematic perspective view illustrating the duplex heat exchanger of an embodiment of the present invention, FIG. 4 is a front view, FIG. 5 is a side view (which is viewed from A-A of FIG. 4), FIG. 6 is a sectional view taken along B-B of FIG. 4, FIG. 7 is a plan view (which is viewed from C-C of FIG. 4), FIG. 8 is a sectional view taken along D-D of FIG. 4, and FIG. 9 is a sectional view taken along E-E of FIG. 4.

The duplex heat exchanger 17 is disposed in the air blowing path of the air conditioner for the vehicle, heats blown air as a condenser during heating operation in winter, and interrupts flow of blown air to pass a refrigerant during cooling operation in summer.

The duplex heat exchanger 17 of the present embodiment includes two heat exchange units 100 and 200 which are disposed so as to be arranged on the front side and the rear side in an air flow direction (an arrow direction of AIR illustrated in FIG. 3). Here, in the two heat exchange units 100 and 200, the heat exchange unit 100 which is positioned on the upstream side in the air flow direction is a refrigerant outlet side heat exchange unit having a refrigerant outlet pipe 110, and the heat exchange unit 200 which is positioned on the downstream side in the air flow direction is a refrigerant inlet side heat exchange unit having a refrigerant inlet pipe 210.

The heat exchange unit 100 includes a pair of upper and lower cylindrical header tanks 101 and 102 which are disposed in parallel with each other, a plurality of tubes 103 which communicates with the header tanks 101 and 102 in parallel, and corrugated fins 104 which are disposed between the tubes 103, and these components are joined to each other by brazing.

Each tube 103 is formed in a flat sectional shape made of aluminum or aluminum alloy, and has a refrigerant channel in the inner portion of the tube.

The corrugated fin 104 is inserted between flat surfaces of the tubes 103 and 103 adjacent to each other, and forms an air passage in the air flow direction.

A lower cylindrical surface of the upper header tank 101 communicates with upper end portions of the plurality of tubes 103. In addition, in the header tank 101, slits are formed in advance so as to fit the tubes 103. Moreover, both right and left end portions of the upper header tank 101 are closed.

An upper cylindrical surface of the lower header tank 102 communicates with lower end portions of the plurality of tubes 103. In addition, in the header tank 102, slits are formed in advance so as to fit the tubes 103. Furthermore, in both right and left end portions of the lower header tank 102, one end portion (right side in the drawing) is closed, but the refrigerant outlet pipe 110 is connected to the other end portion (left side in the drawing). A partition wall 105 which divides a space in the lower header tank 102 into first and second tank internal spaces 102a and 102b is provided on an intermediate portion in a longitudinal direction of the lower header tank 102. The partition wall 105 is formed in a circular plate shape, is inserted into the header tank 102 via a slit formed in the header tank 102 in advance, and is joined to the header tank 102.

In the lower header tank 102, one end side tank space (first tank space) 102a which is partitioned by the partition wall 105 becomes an outflow side tank space of the refrigerant, and the other end side tank space (second tank space) 102b becomes a tank space which communicates with the other heat exchange unit 200 via a connecting member 300 described below.

Similarly to the heat exchange unit 100, the heat exchange unit 200 includes a pair of upper and lower cylindrical header tanks 201 and 202 which are disposed in parallel with each other, a plurality of tubes 203 which communicates with header tanks 201 and 202 in parallel, and corrugated fins 204 which are disposed between the tubes 203, and these components are joined to each other by brazing.

Similarly to the tube 103, each tube 203 is formed in a flat sectional shape made of aluminum or aluminum alloy, and has a refrigerant channel in the inner portion of the tube.

Similarly to the corrugated fin 104, the corrugated fin 204 is inserted between flat surfaces of the tubes 203 and 203 adjacent to each other, and forms an air passage in the air flow direction.

A lower cylindrical surface of the upper header tank 201 communicates with upper end portions of the plurality of tubes 203. In addition, in the header tank 201, slits are formed in advance so as to fit the tubes 203. Furthermore, both right and left end portions of the upper header tank 201 are closed.

An upper cylindrical surface of the lower header tank 202 communicates with lower end portions of the plurality of tubes 203. In addition, in the header tank 202, slits are formed in advance so as to fit the tubes 203. Furthermore, in both right and left end portions of the lower header tank 202, one end portion (right side in the drawing) is closed, but the refrigerant inlet pipe 210 is connected to the other end portion (left side in the drawing). A partition wall 205 which divides a tank internal space into first and second tank internal spaces 202a and 202b is provided on an intermediate portion in a longitudinal direction of the lower header tank 202. The partition wall 205 is formed in a circular plate shape, is inserted into the header tank via a slit formed in the header tank in advance, and is joined to the header tank 102.

In the lower header tank 202, one end side tank space (first tank space) 202a which is partitioned by the partition wall 205 becomes an inflow side tank space of the refrigerant, and the other end side tank space (second tank space) 202b becomes a tank space which communicates with the other heat exchange unit 100 via the connecting member 300 described below.

The fins 104 of the heat exchange unit 100 and the fins 204 of the heat exchange unit 200 are integrally configured so as to connect the front and rear heat exchange units 100 and 200 to each other.

Both end portions of the upper header tanks 101 and 201 of the heat exchange units 100 and 200 are integrally closed by front-rear integral caps 106 and 107. One side (right side) end portion of each of the lower header tanks 102 and 202 of the heat exchange units 100 and 200 is integrally closed by a front-rear integral cap 108. The other side (left side) end portions of the lower header tanks 102 and 202 of the heat exchange units 100 and 200 are connected to the pipes 110 and 210 via a front-rear integral cap 109.

Furthermore, both side portions of the heat exchange units 100 and 200 are reinforced by reinforcing plates 111 and 112 (refer to FIG. 4).

Here, the second tank internal space 102b of the lower header tank 102 of the heat exchange unit 100 and the second tank internal space 202b of the lower header tank 202 of the heat exchange unit 200 are connected to each other by the connecting member 300. A detailed structure of the connecting member 300 in the present embodiment will be described below.

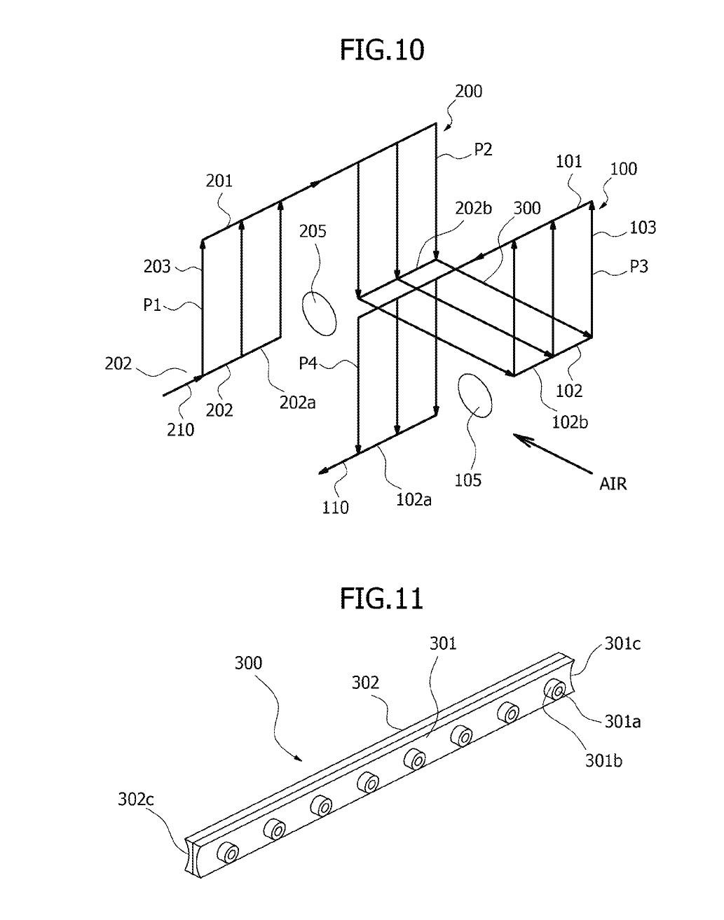

A flow of a refrigerant in the duplex heat exchanger 17 configured as described above is illustrated by arrows of FIG. 10.

The refrigerant flows from the refrigerant inlet pipe 210 of the rear heat exchange unit 200 into the first tank internal space 202a inside the lower header tank 202 which is partitioned by the partition wall 205, flows upward through a group (first pass P1) of the tubes 203 communicating with the first tank internal space 202a, and flows into the upper header tank 201.

The refrigerant which has flowed into the upper header tank 201 flows downward through another group (second pass P2) of the tubes 203, and flows into the second tank internal space 202b inside the lower header tank 202 which is partitioned by the partition wall 205.

Thereafter, the refrigerant flows from the second tank space 202b of the lower header tank 202 of the rear heat exchange unit 200 into the second tank internal space 102b of the lower header tank 102 of the front heat exchange unit 100 which is partitioned by the partition wall 105 via the connecting member 300.

The refrigerant which has flowed into the second tank internal space 102b of the lower header tank 102 of the front heat exchange unit 100 flows upward through a group (third pass P3) of the tubes 103 communicating with the second tank internal space 102b, and flows into the upper header tank 101.

The refrigerant which has flowed into the upper header tank 101 flows downward through another group (fourth pass P4) of the tubes 103, flows into the first tank internal space 102a inside the lower header tank 102 which is partitioned by the partition plate 105, and flows out from the refrigerant outlet pipe 110.

In the flow structure, the rear heat exchange unit 200 in the air flow direction is positioned on the upstream side in the flow direction of the refrigerant, the front heat exchange unit 100 in the air flow direction is positioned on the downstream side in the flow direction of the refrigerant, and this case is a so-called counter-flow in which the flow direction of the refrigerant and the air flow direction face each other. Accordingly, a temperature difference between the air and the refrigerant is able to be made uniform in the air flow direction, and it is possible to increase heat exchange efficiency.

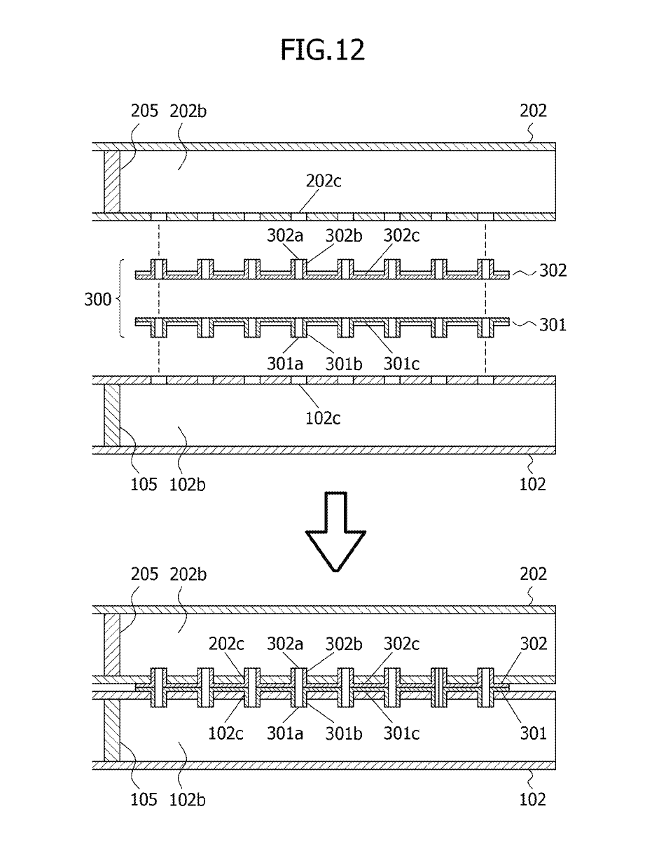

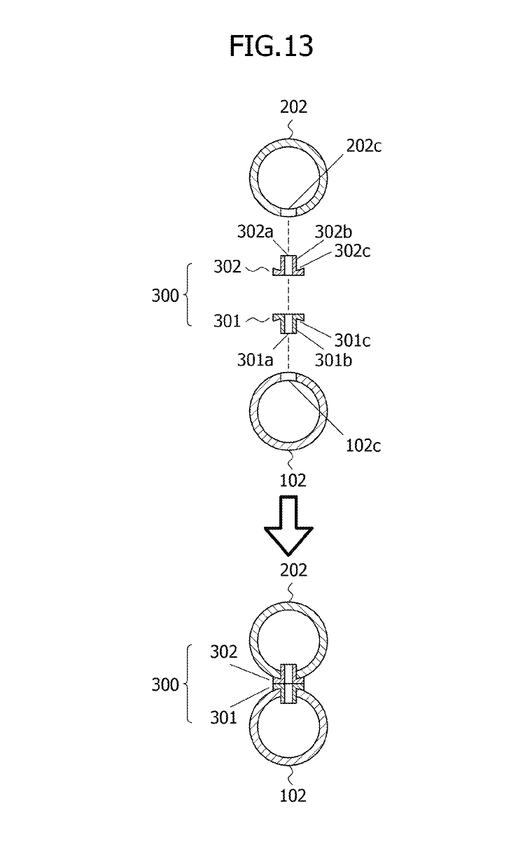

A detailed structure of the connecting member 300 in the present embodiment will be described with reference to FIGS. 11 to 13. FIG. 11 is a perspective view of the connecting member, FIG. 12 is an assembly process view of a connection portion including the connecting member when viewed from a cross section, and FIG. 13 is an assembly process view of the connection portion including the connecting member when viewed from a vertical section.

The connecting member 300 is configured of two narrow and long plate members 301 and 302. The plate members 301 and 302 have shapes that are identical to each other.

In each of the plate members 301 and 302, a plurality of communication holes 301a and 302a is formed so as to be arranged with predetermined intervals in longitudinal directions thereof.

The communication holes 301a and 302a are formed by burring, and include boss portions 301b and 302b which cylindrically protrude from one surface of each of the plate members 301 and 302.

Furthermore, cylindrical surfaces 301c and 302c having the same curvature as the cylindrical surfaces of the header tanks 102 and 202 are formed on the one surface, from which the boss portions 301b and 302b of the plate members 301 and 302 protrude, by step-pressing.

Each of the plate members 301 and 302 is a clad metal having brazing filler metals on a rear surface (which is opposite to the surface from which each of the boss portions 301b and 302b protrudes), and burring and step-pressing are performed on the clad metal. Finally, two plate members 301 and 302 are joined to each other back to back.

Meanwhile, holes 102c and 202c into which the boss portions 301b and 302b are inserted are formed with predetermined intervals in the longitudinal directions on facing cylindrical surfaces of two header tanks 102 and 202 (particularly, portions of the second tank internal spaces 102b and 202b) which communicate with each other by the connecting member 300. The brazing filler metals are coated on outer circumferential surfaces of the header tanks 102 and 202 (this similarly applies to 101 and 201).

Accordingly, when assembly is performed, the boss portions 301b of one plate member 301 are inserted into the holes 102c of the header tank 102, and the cylindrical surface 301c of the plate member 301 is joined to the cylindrical surface of the header tank 102. The boss portions 302b of the other plate member 302 are inserted into the holes 202c of the header tank 202, and the cylindrical surface 302c of the plate member 302 is joined to the cylindrical surface of the header tank 202. Thus, the plate members 301 and 302 are joined to each other back to back. All components including the header tanks 101, 102, 201, and 202, the tubes 103 and 203, and the corrugated fins 104 and 204 are joined to one another by brazing in a heating furnace, and simultaneously, the connecting member 300 is joined by brazing.

Here, the communication holes 301a and 302a of the connecting member 300 are provided so as to be positioned between the end portions of the plurality of tubes 103 and 203, through which the header tanks 102 and 202 communicate with each other, in longitudinal directions of the header tanks 102 and 202 communicating with each other (refer to FIG. 9).

Furthermore, preferably, a minimum clearance between the header tanks 102 and 202 facing each other via the connecting member 300 is set to be 1 mm or more by adjusting a thickness of the connecting member 300. When the minimum clearance is less than 1 mm, the header tanks 102 and 202 facing each other are thermally connected by the brazing filler metals due to flows of the brazing filler metals generated when the brazing joining is performed, so that effects of the counter-flow or the like may be decreased. In practice, the inventors tested the heat exchanger when the minimum clearance was set to 0 mm, 0.5 mm, and 1.0 mm. When the minimum clearance was 0 mm, thermal conduction between tanks was generated due to brazing flow, when the minimum clearance was 0.5 mm, the thermal conduction between tanks was partially generated due to the brazing flow, and when the minimum clearance was 1.0 mm, the thermal conduction between tanks due to the brazing flow could be prevented. However, since a size of a heat exchanger increases according to the minimum clearance exceeding 1 mm, preferably, the minimum clearance is set to approximately 1 mm.

According to the present embodiment, the connecting member 300 is able to be configured of two plate members 301 and 302 formed by simple processing, and communication between the plurality of communication holes 301a and 302a is able to be achieved. Accordingly, it is possible to decrease flow resistance without increasing the number of parts and assembly steps.

Furthermore, the two plate members 301 and 302 are the similar parts having identical shapes, and thus, it is possible to easily manage the plate members. In addition, since processing with respect to the plate members 301 and 302 includes only burring and step-pressing, it is possible to easily perform the processing. The burring is processing performed in the same direction, and thus, has excellent workability.

Furthermore, according to the present embodiment, the communication holes 301a and 302a of the connecting member 300 are provided so as to be positioned between end portions of the plurality of tubes 103 and 203 communicating with the header tanks 102 and 202 in longitudinal directions of the header tanks 102 and 202 to which the connecting member 300 is joined. Accordingly, the plurality of communication holes 301a and 302a can be effectively disposed while avoiding interference between the connecting member 300 and the tubes 103 and 203, and thus, it is possible to effectively decrease flow resistance.

Furthermore, according to the present embodiment, the plate members 301 and 302 configuring the connecting member 300 have the cylindrical surfaces 301c and 302c from which the boss portions 301b and 302b protrude and which have the same curvature as the cylindrical surfaces of the header tanks 102 and 202 by performing step-pressing on the surfaces 301c and 302c. Accordingly, it is possible to achieve good joining in which leakage or the like does not easily occur.

Moreover, according to the present embodiment, as the plate members 301 and 302 configuring the connecting member 300, the clad metal having brazing filler metals on the rear surface sides of the plate members 301 and 302 are used to easily perform the joining. If the brazing filler metals are provided on both surface sides of the plate members 301 and 302, that is, if the brazing filler metals are provided on the surfaces of the header tanks 102 and 202 sides in addition to the rear surface sides, since the brazing filler metals are coated on the outer circumferential sides of the header tanks 102 and 202 in advance, the coated amount of the brazing filler metals are excessive, and thus, problems such as burn-out easily occur. Accordingly, it is effective to provide the brazing filler metals on only the rear surface sides of the plate members 301 and 302.

Furthermore, according to the present embodiment, since the minimum clearance between the header tanks 102 and 202 facing each other via the connecting member 300 is set to 1 mm or more, it is possible to prevent thermal short-circuit of the header tanks 102 and 202 due to the brazing filler metals, and it is possible to maintain required heat exchange performance.

Moreover, according to the present embodiment, the header tanks 102 and 202 provided on one side of the heat exchange units 100 and 200 include the partition walls 105 and 205 which partition tank spaces in the intermediate portion in the longitudinal direction. In the two tank spaces divided by each of the partition walls 105 and 205, the tank spaces 102a and 202a provided on one end side are the inflow side tank spaces or the outflow side tank spaces of the refrigerant, and the tank spaces 102b and 202b provided on the other end side are the tank spaces which communicate with another heat exchange unit via the connecting member 300. Accordingly, it is possible to increase heat exchange efficiency in a four-pass type.

Moreover, according to the present embodiment, in the four-pass type, the communication holes 301a and 302a of the connecting member 300 are provided on the entire region of the tank spaces 102b and 202b provided on the other end side in the longitudinal directions of the header tanks 102 and 202 to which the connecting member 300 is connected. Accordingly, it is possible to effectively decrease the circulation resistance of the refrigerant. However, the present invention is not limited to the four-pass type, and may be a two-pass type which is the simplest type.

Furthermore, the present embodiment is applied to the vehicle interior heat exchanger 17 which is disposed in the air blowing path of the air conditioner for the vehicle and is configured to be used as a condenser which heats air by condensing the refrigerant from the compressor 20 during the heating operation, and to interrupt the blown air during the cooling operation so as to pass the refrigerant from the compressor 20 in a gas state to thereby supply the refrigerant to the exterior condenser 22. As a result, it is possible to effectively decrease the flow resistance during the cooling operation in the vehicle heat exchanger 17. However, it is needless to say that the present invention may be applied to other heat exchangers.

Here, some related art will be described.

Japanese Patent Application Laid-Open Publication No. H11-325788 discloses a connecting member for a header tank. However, this connecting member does not connect header tanks to each other, but connects the header tank to a receiver tank. Furthermore, even when this connecting member includes two plate members, the plate members do not have identical shapes, and the plate members are not easily processed. In addition, since intended purposes between the present invention and the related art are different from each other, the number of the communication holes is small.

Moreover, Japanese Patent Application Laid-Open Publication No. 2003-21490 also discloses a connecting member for a header tank. However, this connecting member also does not connect header tanks to each other, but connects the header tank to a receiver tank. In addition, in the connecting member, boss portions protrude from both surfaces of the plate member by burring. Accordingly, there is a possibility that the plate member may be fractured, and the connection is not easily processed.

Particularly, in the case of the receiver tank, an outline of the tank is large, and a curvature radius is large even when the tank has a cylindrical surface. Accordingly, a burring height of the boss portion is not required.

Meanwhile, in connection between the header tanks, since a curvature radius of the cylindrical surface is small, particularly, a diameter of the header tank decreases in the duplex heat exchanger, it is necessary to secure the burring height of the boss portion in order to achieve a stable connection. Accordingly, the configuration according to the present embodiment is required.

The embodiments illustrated in the drawings are only examples of the present invention, and it is a matter of course that the present invention includes not only the constructions directly illustrated in the above embodiments, but also various improvements and modifications within the scope of claims usually performed by one skilled in the art.

### REFERENCE SYMBOL LIST

1 HVAC UNIT
2 HEAT PUMP CIRCUIT
10 HOUSING
11 AIR BLOWING PATH
12 INSIDE AIR INTAKE PORT
13 OUTSIDE AIR INTAKE PORT
14 INSIDE AND OUTSIDE AIR CHANGEOVER DAMPER
15 BLOWER
16 FIRST VEHICLE INTERIOR HEAT EXCHANGER (EVAPORATOR DURING COOLING OPERATION)
17 SECOND VEHICLE INTERIOR HEAT EXCHANGER (CONDENSER DURING HEATING OPERATION)
18 BYPASS PATH
19 AIR MIX DAMPER
20 COMPRESSOR
21 DECOMPRESSION UNIT SUCH AS EXPANSION VALVE
22 VEHICLE EXTERIOR HEAT EXCHANGER (CONDENSER DURING COOLING OPERATION, EVAPORATOR DURING HEATING OPERATION)
23 DECOMPRESSION UNIT SUCH AS EXPANSION VALVE
24 BYPASS PIPE
25 ON-OFF VALVE (OPEN DURING COOLING OPERATION)
26 BYPASS PIPE
27 ON-OFF VALVE (OPEN DURING HEATING OPERATION)
28 FAN
100 HEAT EXCHANGE UNIT
101 UPPER HEADER TANK
102 LOWER HEADER TANK
102a, 102b FIRST AND SECOND TANK INTERNAL SPACE
102c HOLE
103 TUBE
104 CORRUGATED FIN
105 PARTITION WALL
106 TO 109 CAP
110 REFRIGERANT OUTLET PIPE
111,112 REINFORCING PLATE
200 HEAT EXCHANGE UNIT
201 UPPER HEADER TANK
202 LOWER HEADER TANK
202a, 202b FIRST AND SECOND TANK INTERNAL SPACE
202c HOLE
203 TUBE
204 CORRUGATED FIN
205 PARTITION WALL
210 REFRIGERANT INLET PIPE
300 CONNECTING MEMBER
301,302 PLATE MEMBER
301a, 302a COMMUNICATION HOLE
301b, 302b BOSS PORTION
301c, 302c CYLINDRICAL SURFACE FORMED BY STEP-PRESSING

1. A duplex heat exchanger comprising at least two heat exchange units, each heat exchange unit which includes: a pair of cylindrical header tanks which are disposed in parallel with each other; and a plurality of tubes which communicates with the pair of header tanks in parallel, and the heat exchange unit which performs heat exchange between a refrigerant flowing through the tubes and air flowing through gaps between the tubes, in which the heat exchange units are disposed to be arranged in upstream and downstream sides in an air flow direction, and the header tanks positioned on one side communicate with each other via a connecting member,
wherein the connecting member includes two identically shaped long and narrow plate members, a plurality of communication holes having boss portions protruding cylindrically by burring from one surface of each of the plate members, is formed to be arranged on the plate members, and the plate members are joined to each other back to back, and
wherein the connecting member is disposed between the two header tanks which communicate with each other, and the boss portions are inserted into holes formed on the header tank, so that the connecting member is joined to the header tanks.

2. The duplex heat exchanger according to claim 1,
wherein each communication hole of the connecting member is provided to be positioned between end portions of the plurality of tubes communicating with the header tanks in a longitudinal direction of the header tank to which the connecting member is joined.

3. The duplex heat exchanger according to claim 1,
wherein in the plate member configuring the connecting member, the one surface from which the boss portions protrude is formed to be a cylindrical surface having the same curvature as the cylindrical surface of the header tank by step-pressing.

4. The duplex heat exchanger according to claim 1,
wherein the plate member configuring the connecting member is a clad metal which includes brazing filler metals on a rear surface side thereof.

5. The duplex heat exchanger according to claim 1,
wherein a minimum clearance between the header tanks facing each other via the connecting member is 1 mm or more.

6. The duplex heat exchanger according to claim 1,
wherein the header tank disposed on one side of each heat exchange unit includes a partition wall which partitions a tank space in an intermediate portion in the longitudinal direction, and
wherein in two tank spaces partitioned by the partition wall, one end side tank space is an inflow side tank space or an outflow side tank space of the refrigerant, and the other end side tank space is a tank space which communicates with the other heat exchange unit via the connecting member.

7. The duplex heat exchanger according to claim 6,
wherein the communication holes of the connecting member are provided on the entire region of the other end side tank space in the longitudinal direction of the header tank to which the connecting member is joined.

8. The duplex heat exchanger according to claim 1,
wherein the duplex heat exchanger is disposed in an air blowing path of an air conditioner for a vehicle, and is configured to be used as a condenser which heats air by condensing a refrigerant from a compressor during heating operation, and to interrupt blown air so as to pass the refrigerant from the compressor in a gas state to thereby supply the refrigerant to an exterior condenser during cooling operation.

9. The duplex heat exchanger according to claim 2,
wherein in the plate member configuring the connecting member, the one surface from which the boss portions protrude is formed to be a cylindrical surface having the same curvature as the cylindrical surface of the header tank by step-pressing.

10. The duplex heat exchanger according to claim 2,
wherein the plate member configuring the connecting member is a clad metal which includes brazing filler metals on a rear surface side thereof.

11. The duplex heat exchanger according to claim 3,
wherein the plate member configuring the connecting member is a clad metal which includes brazing filler metals on a rear surface side thereof.

12. The duplex heat exchanger according to claim 2,
wherein a minimum clearance between the header tanks facing each other via the connecting member is 1 mm or more.

13. The duplex heat exchanger according to claim 3,
wherein a minimum clearance between the header tanks facing each other via the connecting member is 1 mm or more.

14. The duplex heat exchanger according to claim 4,
wherein a minimum clearance between the header tanks facing each other via the connecting member is 1 mm or more.

15. The duplex heat exchanger according to claim 2,
wherein the header tank disposed on one side of each heat exchange unit includes a partition wall which partitions a tank space in an intermediate portion in the longitudinal direction, and
wherein in two tank spaces partitioned by the partition wall, one end side tank space is an inflow side tank space or an outflow side tank space of the refrigerant, and the other end side tank space is a tank space which communicates with the other heat exchange unit via the connecting member.

16. The duplex heat exchanger according to claim 3,
wherein the header tank disposed on one side of each heat exchange unit includes a partition wall which partitions a tank space in an intermediate portion in the longitudinal direction, and
wherein in two tank spaces partitioned by the partition wall, one end side tank space is an inflow side tank space or an outflow side tank space of the refrigerant, and the other end side tank space is a tank space which communicates with the other heat exchange unit via the connecting member.

17. The duplex heat exchanger according to claim 4,
wherein the header tank disposed on one side of each heat exchange unit includes a partition wall which partitions a tank space in an intermediate portion in the longitudinal direction, and
wherein in two tank spaces partitioned by the partition wall, one end side tank space is an inflow side tank space or an outflow side tank space of the refrigerant, and the other end side tank space is a tank space which communicates with the other heat exchange unit via the connecting member.

18. The duplex heat exchanger according to claim 5,
wherein the header tank disposed on one side of each heat exchange unit includes a partition wall which partitions a tank space in an intermediate portion in the longitudinal direction, and
wherein in two tank spaces partitioned by the partition wall, one end side tank space is an inflow side tank space or an outflow side tank space of the refrigerant, and the other end side tank space is a tank space which communicates with the other heat exchange unit via the connecting member.

19. The duplex heat exchanger according to claim 2,
wherein the duplex heat exchanger is disposed in an air blowing path of an air conditioner for a vehicle, and is configured to be used as a condenser which heats air by condensing a refrigerant from a compressor during heating operation, and to interrupt blown air so as to pass the refrigerant from the compressor in a gas state to thereby supply the refrigerant to an exterior condenser during cooling operation.

20. The duplex heat exchanger according to claim 3,
wherein the duplex heat exchanger is disposed in an air blowing path of an air conditioner for a vehicle, and is configured to be used as a condenser which heats air by condensing a refrigerant from a compressor during heating operation, and to interrupt blown air so as to pass the refrigerant from the compressor in a gas state to thereby supply the refrigerant to an exterior condenser during cooling operation.
